(19) United States
(12) Patent Application Publication
(10) Pub. No.: US 2026/0325952 A1
(43) Pub. Date: Oct. 22, 2026

(54) SCORE FOUR BOARD AND SCORE FOUR

(71) Applicant: FS GIIKER TECHNOLOGY CO., LTD., Foshan, Guangdong (CN)

(72) Inventors: Ziming SU, Foshan (CN); Changping LI, Foshan (CN); Ningqing LI, Foshan (CN)

(21) Appl. No.: 19/119,371

(22) PCT Filed: Feb. 27, 2023
(86) PCT No.: PCT/CN2023/078367

§ 371 Date: Apr. 8, 2025

(30) Foreign Application Priority Data
Nov. 1, 2022 (CN) 202222895185.X

(51) Int. Cl. A63F 3/02; A63F 3/00

(52) U.S. Cl. CPC A63F 3/02; A63F 3/00643; A63F 2003/00646; A63F 2003/00671

(57) ABSTRACT

The present disclosure relates to a three-dimensional connect four chessboard and a three-dimensional connect four. The three-dimensional connect four chessboard comprises: an upper panel provided with a number of chess move areas, the chess move areas being configured to stack chess pieces, the chess move areas being arranged in an array of M rows and N columns, and both M and N being natural numbers greater than or equal to 5; a detection module comprising a plurality of detectors each of which is correspondingly provided in a chess move area and is configured to detector a chess move position of a chess piece; a processor connected to the detection module; and a chess move position prompt module connected to the processor and configured to indicate a position of a corresponding chess move area.

### CROSS-REFERENCE TO RELATED APPLICATIONS

The present application is a US National Phase application of PCT international application PCT/CN2023/078367, filed on Feb. 27, 2023, entitled “SCORE FOUR BOARD AND SCORE FOUR”, which claims priority to Chinese Patent Application No. 202222895185.X, filed Nov. 1, 2022, entitled “SCORE FOUR BOARD AND SCORE FOUR”. Patent Cooperation Treaty application serial no. PCT/CN2023/078367, published as WO 2024/093060, and Chinese patent application serial no. 202222895185.X, the content of which is expressly incorporated herein by reference in its entirety.

### TECHNICAL FIELD

The present disclosure relates to the field of chessboard game technology, and particularly to a three-dimensional connect four chessboard and three-dimensional connect four.

### BACKGROUND

Three-dimensional connect four is also referred to as score four. The chess pieces can be stacked on a chessboard. When four chess pieces of a player are connected in a straight line in a vertical direction, a horizontal direction, or an oblique direction, the player wins. As for the three-dimensional connect four in the conventional technology, only two people can play face to face. However, when man and machine play the three-dimensional connect four, the user is required to help the machine to place the chess pieces, and accordingly how to enable the user to determine a position where a chess piece is dropped becomes an urgent problem to be solved.

### SUMMARY

In view of this, as for the above-mentioned technical problem, it is necessary to provide a three-dimensional connect four chessboard enabling a user to determine the position of the chess move.

In the first aspect of the present disclosure, a three-dimensional connect four chessboard is provided, including: an upper panel provided with a number of chess move areas, the chess move areas being configured to stack chess pieces, the chess move areas being arranged in an array of M rows and N columns, and both M and N being natural numbers greater than or equal to 5; a detection module including a plurality of detectors each of which is correspondingly provided in a chess move area and is configured to detector a chess move position of a chess piece; a processor connected to the detection module; and a chess move position prompt module connected to the processor and configured to indicate a position of a corresponding chess move area.

In an embodiment, the chess move position prompt module includes a color identification assembly and a position identification assembly, the color identification assembly includes N color identification members with different colors in each row, each color identification member is provided to correspond to one chess move area, the position identification assembly is configured to identify a row number and a color of a color identification member.

In an embodiment, the position identification assembly includes M row number identification lamps each of which is provided on a side of each row of color identification members, the row number identification lamp is configured to emit color light of N different colors, the position identification assembly is configured to control a specific row number identification lamp to emit light.

In an embodiment, the the position identification assembly includes a row number display lamp configured to display a number to identify a row number of a color identification member, and configured to emit color light of N different colors, and further configured to display a number of a specific color.

In an embodiment, the chess move position prompt module includes a position display screen provided on the upper panel, the position display screen includes a plurality of position display lamps arranged in an array, the position display lamps have the same array arrangement mode as the chess move areas, the position display screen is configured to control the position display lamps to glow or flicker.

In an embodiment, the detection module is configured to output a plane position signal; the processor is configured to determine current spatial position information of a chess piece according to the plane position signal and the number of chess moves, and output a chess move position prompt signal according to the current spatial position information and historical spatial position information; the chess move position prompt module is configured to indicate a position of a corresponding chess move area according to the chess move position prompt signal.

In an embodiment, the three-dimensional connect four chessboard may further include a chess move player prompt module connected to the processor, the processor is configured to generate a chess move player prompt signal, the chess move player prompt module is configured to prompt a type of a chess piece to be placed according to the chess move player prompt signal.

In an embodiment, the chess move player prompt module includes a first display lamp and a second display lamp, the chess move player prompt module is configured to control the first display lamp or the second display lamp to glow or flicker according to the chess move player prompt signal.

In an embodiment, the three-dimensional connect four chessboard may further include a wireless module connected to the processor and configured to acquire a wireless control signal, the processor is configured to generate a chess move position prompt signal according to the wireless control signal.

In the second aspect of the present disclosure, a three-dimensional connect four is provided, including chess pieces and a chessboard, the chessboard includes the three-dimensional connect four chessboard in the embodiments of the first aspect.

As for the above-mentioned three-dimensional connect four chessboard and the three-dimensional connect four, the detection module is provided to detector the position of the chess move of the chess piece, the processor determines the current spatial position information of the chess piece according to the acquired position of the chess move, and obtains, according to the current spatial position information of the chess piece, the position information of the chess piece needing to perform the next chess move, and outputs the corresponding prompt signal. After receiving the corresponding prompt signal, the provided chess move position prompt module indicates the position of the chess move area in which the chess move needs to be performed, thereby achieving the technical effect that the user help the machine to perform the chess move in the process of the man-machine battle game.

### BRIEF DESCRIPTION OF THE DRAWINGS

In order to describe the technical solution in the embodiments of the present disclosure or the conventional technology more clearly, the accompanying drawings required for describing the embodiments or the conventional technology are briefly introduced. Obviously, the accompanying drawings in the following description show merely some embodiments of the present disclosure, and a person of ordinary skill in the art may still obtain other drawings from these accompanying drawings without any creative efforts:

FIG. 1 is a schematic block diagram illustrating a three-dimensional connect four chessboard according to an embodiment.

FIG. 2 is a perspective view of a three-dimensional connect four chessboard according to an embodiment.

FIG. 3 is a top view of a three-dimensional connect four chessboard according to an embodiment.

FIG. 4 is a top view of a three-dimensional connect four chessboard according to another embodiment.

FIG. 5 is a top view of a three-dimensional connect four chessboard according to another embodiment.

FIG. 6 is a schematic block diagram of a three-dimensional connect four chessboard according to another embodiment.

### REFERENCE SIGNS

100, upper panel; 200, detection module; 300, processor; 400, chess move position prompt module; 500, chess move player prompt module; 600, wireless module; 110, chess move area; 110, 410, color identification assembly; 411, color identification member; 420, position identification assembly; 421, row number identification lamp; 422, row number display lamp; 430, position display screen; 431, position display lamp.

### DETAILED DESCRIPTION

In order to make the aforementioned purpose, limitations, and advantages of the present disclosure more obvious and easy to understand, the specific implementation modes of the present disclosure will be elaborated below with reference to the accompanying drawings. Many specific details are described in the following description to facilitate a full understanding of the present disclosure. However, the present disclosure may be implemented in many different modes from those described herein. A person skilled in the art may make similar improvements without departing from the concept of the present disclosure. Therefore, the present disclosure is not limited to the specific embodiments disclosed below.

In the present disclosure, unless otherwise specified and limited, terms such as “installation”, “coupling”, “connection”, and “fixing”, etc., should be understood in a broad sense. For example, the connection may be a fixed connection, or a detachable connection, or may be integrated into one. Further, the connection may be a mechanical connection or an electrical connection, may be a direct connection or an indirect connection through an intermediate medium, may be a communication between two elements, or an interaction relationship between the two elements, unless otherwise specifically limited. A person of ordinary skill in the art may understand the specific meaning of the above-mentioned terms in the present disclosure according to specific situations.

It should be noted that when a component is referred to as being “fixed to” or “provided on” another component, it may be directly on another component or there may exist an intermediate component. When one component is referred to as being “connected to” another component, it may be connected directly to another component or there may exist an intermediate component. The terms “vertical”, “horizontal”, “upper”, “lower”, “left”, “right” and similar expressions used herein are merely for illustration and are not intended to represent the only implementation mode.

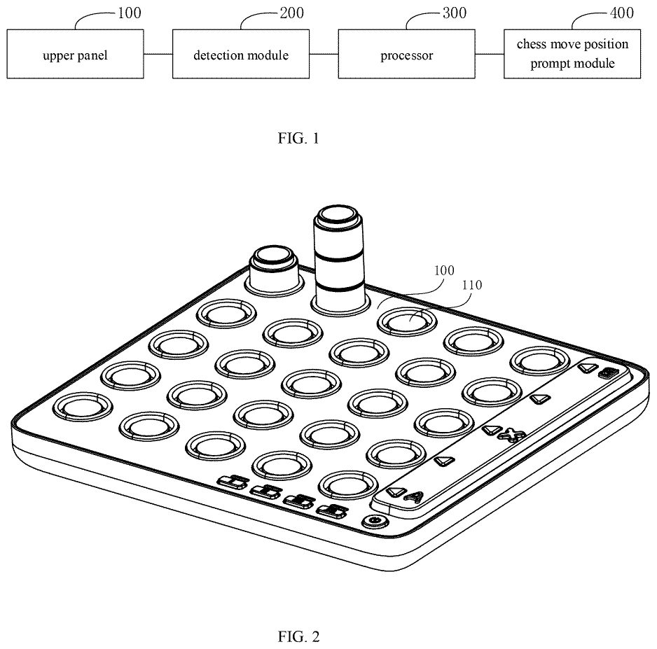

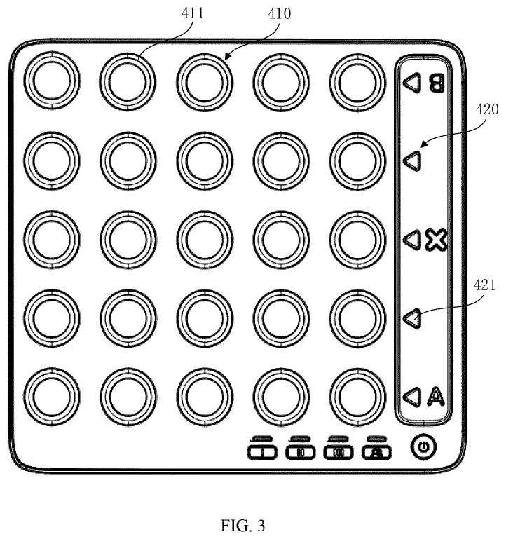

In an embodiment, referring to FIG. 1 and FIG. 2, a three-dimensional connect four chessboard is provided, including an upper panel 100, a detection module 200, a processor 300, and a chess move position prompt module 400. The upper panel 100 is provided with a number of chess move areas 110. The chess move areas 110 are configured to stack chess pieces. The chess move areas 110 are arranged in an array of M rows and N columns, and both M and N are natural numbers greater than or equal to 5. The detection module 200 includes a plurality of detectors (not shown in the figures), each detector is correspondingly provided in the chess move area 110, and the detector is configured to detector a chess move position of a chess piece. The processor 300 is connected to the detection module 200. The chess move position prompt module 400 is connected to the processor 300, and is configured to indicate a position of a corresponding chess move area 110.

Specifically, as shown in FIG. 2, the upper panel 100 is set to 5×5 chess move areas 110, and all chess move areas 110 are arranged in a square matrix form. The chess move areas 110 are configured to stack the chess pieces. Generally, the chess pieces are divided into two different colors for the use of both players or both a human and a machine. When four chess pieces of a player are connected in a straight line in a vertical direction, a horizontal direction, or an oblique direction, the player wins. The material of the upper panel 100 may be plastic. The chess move area 110 may be provided with a groove, in order to facilitate placement of a chess piece. It should be appreciated that, in order to improve the complexity of the game, the number of rows and columns of the chess move areas 110 can be increased.

The detection module 200 may include a number of detectors, and the number of the detectors is the same as the number of the chess move areas 110. Each chess move area 110 is provided with one detector. The detection module 200 may obtain a corresponding plane position signal by combining detection results of all detectors. The detector can detector a chess move position of a chess piece through the following modes. For example, the detector is implemented with a gravity sensor, and the gravity sensor can collect and output a pressure applied on a current chess move area 110. A calculation unit in the detection module 200 determines a specific chess move position of a chess piece by determining gravity magnitudes at a current moment and a previous moment. The detector is alternatively implemented with a string rod with a number of optical sensors provided at equal intervalsthereon. Each chess piece is provided with a hole for the string rod to pass through. When no chess piece moves, all the optical sensors on the string rod can sense external optical signals. After a chess piece moves, parts of the optical sensors are shielded by the chess piece, and accordingly cannot sense the optical signals. The detection module 200 can obtain the chess move position of the current chess piece according to changes of the corresponding optical signals.

The processor 300 is provided inside the three-dimensional connect four chessboard and is electrically connected to the detection module 200, to obtain a plane position signal outputted by the detection module 200. It should be appreciated that the plane position signal is a plane position coordinate of a current chess piece on the upper panel 100, and is a two-dimensional coordinate. By combining the number of chess moves in the current position, a height position at which the current chess piece is located can be obtained, so that current three-dimensional spatial position information of the current chess piece can be obtained. In the meantime, the processor may further store historical spatial position information of other chess pieces, and spatial position information of all chess pieces on the upper panel 100 may be obtained by combining the current spatial position information. When playing the game, each of the two players places one chess piece in turn. Accordingly, the processor 300 may determine which player the current chess piece belongs to according to the number of the chess moves. The processor 300 can determine the winner of the game according to the spatial position information of all chess pieces. Alternatively, when a human and the machine are playing the game, the spatial position information of all chess pieces is calculated by using a preset algorithm after the player completes one chess move such that a position of a chess move that the machine needs to perform is obtained, and a corresponding chess move position prompt signal is outputted to remind the player of the position of the chess move the machine needs to perform.

The chess move position prompt module 400 is connected to the processor 300 and is configured to receive a chess move position prompt signal. After receiving the chess move position prompt signal, the chess move position prompt module 400 indicates, according to the chess move position prompt signal, a position of a chess move area 110 in which the chess move needs to be performed. For example, an indicator light may be provided near each chess move area 110 on the upper panel 100. When a chess move is performed in a corresponding chess move area 110, a corresponding indicator light glows, in order to prompt the player to perform the chess move in the corresponding chess move area 110. It should be appreciated that, in some other embodiments, a voice prompt module may be provided to prompt, in a voice broadcast mode, a position in which a chess move needs to be performed.

In the above-mentioned three-dimensional connect four chessboard, the detection module 200 is provided to detector the positions of the chess moves of the chess pieces, and output the corresponding plane position signals. The processor 300 determines the spatial position information of the chess pieces according to the acquired plane position signals and the number of the chess moves recorded by the processor itself, obtains, according to the spatial position information of the chess pieces, the position information of the chess piece needing to perform the next chess move, and outputs the chess move position prompt signal. After receiving the corresponding chess move position prompt signal, the provided chess move position prompt module 400 indicates the position of the chess move area 110 in which the chess move needs to be performed, thereby achieving the technical effect that the user helps the machine to perform the chess moves in the process of the human-machine battle game.

In an embodiment, as shown in FIG. 3, the chess move position prompt module 400 includes a color identification assembly 410 and a position identification assembly 420. The color identification assembly 410 includes N color identification members 411 with different colors in each row, and each color identification member 411 is provided to correspond to one chess move area 110. The position identification assembly 420 is configured to identify a row number and the color of the color identification member 411.

Specifically, the color identification member in FIG. 3 is a circular ring with a color, and the color identification member is provided around the chess move area 110. In the color identification assembly 410, color identification members 411 in each row have different colors, while color identification members 411 in the same column may have the same color. For example, in FIG. 3, the colors of the color identification members 411 in the first row are respectively red, orange, yellow, green, and blue, and the colors of the color identification members 411 in the first column are all red. After acquiring the chess move position prompt signal, the position identification assembly 420 may identify the row number and the color of the color identification member 411. For example, the position identification assembly 420 identifies a color identification member as a green identification member in the first row, in this case, the user may determine, according to the identification of the position identification assembly 420, a specific position in which the chess move needs to be performed by the machine. By providing the color identification assembly 410 and the position identification assembly 420 in the embodiment of the present disclosure, there is no need to provide one indicator light in each chess move area 110, thereby reducing the number of the indicator lights and reducing the production cost.

In an embodiment, the position identification assembly 420 includes M row number identification lamps 421, each row number identification lamp 421 is provided on a side of each row of color identification members 411. The row number identification lamp 421 is configured to emit color light of N different colors. The position identification assembly 420 is configured to control a specific row number identification lamp 421 to emit light. Specifically, a row number identification lamp 421 in FIG. 3 is provided on the right side of each row of color identification members 411, and is provided in a triangular shape. When the row number identification lamp 421 emits light, a row in which the chess move area 110 where the chess move needs to be performed is located, is identified. In the meantime, a color identification member 411 of a specific color in the current row may be determined according to the color light emitted by the row number identification lamp 421, thereby determining a specific position where the chess move needs to be performed.

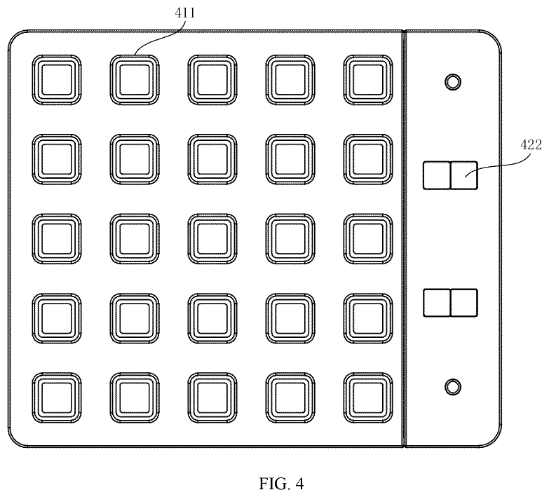

In an embodiment, as shown in FIG. 4, the position identification assembly 420 includes a row number display lamp 422 which is configured to display a number for identifying a row number of a color identification member 411. The row number display lamp 422 is configured to emit color light of N different colors, and is configured to display a number of a specific color.

Specifically, the row number display lamp 422 in the embodiment of the present disclosure is a seven-segment digital tube, and can display numbers 1 to 9. The displayed numbers are configured to identify row numbers of the color identification members 411. In the meantime, the row number display lamp 422 may further change the color of the displayed number, and the color identification member 411 of the specific color in the current row can be identified by the color. For example, when the row number display lamp 422 displays the blue number 3, it indicates that a position in which the chess move needs to be performed is the chess move area 110 identified by the blue identification member 411 in the third row. In some other embodiments, two prompt buttons may be further provided, and two row number display lamps 422 may be provided. When a player needs a prompt for a chess move, a corresponding row number display lamp 422 may be displayed by pressing the button, to complete the prompt of the position of the chess move for the current player.

In an embodiment, the color identification member 411 may be a plastic ring which is provided around the chess move area 110. Specifically, the color identification member 411 in FIG. 3 is a plastic ring, and the color identification member 411 in FIG. 4 is a plastic square ring. In some other embodiments, color marks may also be printed on the upper panel 100 to identify different chess move areas 110.

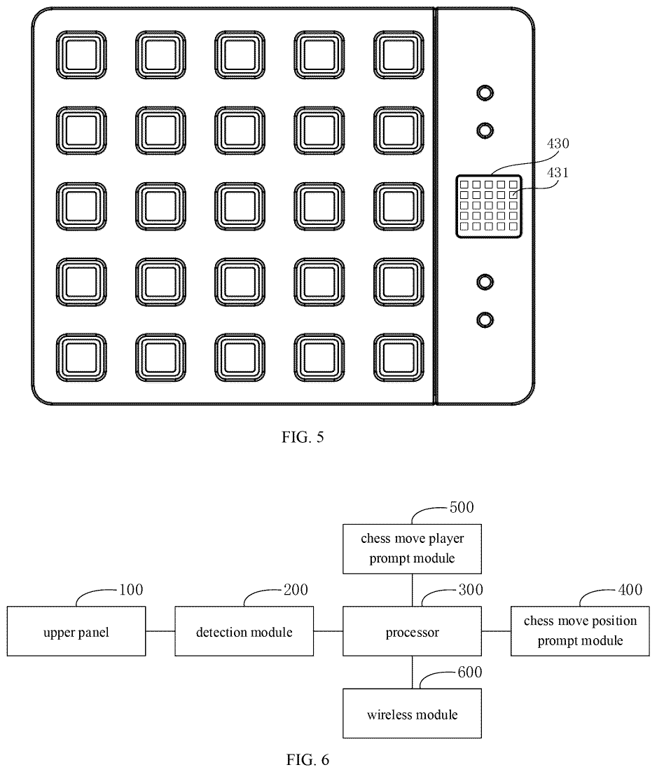

In an embodiment, as shown in FIG. 5, the chess move position prompt module 400 may include a position display screen 430 which is provided on the upper panel 100. The position display screen 430 may include a plurality of position display lamps 431 arranged in an array. The position display lamps 431 have the same array arrangement mode as the chess move areas 110. The position display screen 430 is configured to control the position display lamps 431 to glow or flicker.

Specifically, there is no need to provide the color identification assembly 410 in the embodiment, the position display screen 430 is an LED display screen, the position display screen 430 includes a plurality of position display lamps 431, and the plurality of position display lamps 431 have the same array arrangement mode as the chess move areas 110. For example, the chess move areas 110 are arranged in a 5×5 array, and the position display lamps 431 are also arranged in a 5×5 array. After receiving the chess move position prompt signal, the position display screen 430 controls the corresponding position display lamp 431 to glow or flicker. The player may correspondingly determine, according to the position of the position display lamp 431, the position of the chess move area 110 in which the chess move needs to be performed.

In an embodiment, the detection module 200 is configured to output a plane position signal. The processor 300 is configured to determine current spatial position information of a chess piece according to the plane position signal and the number of chess moves, and output a chess move position prompt signal according to the current spatial position information and historical spatial position information. The chess move position prompt module 400 is configured to indicate a position of a corresponding chess move area according to the chess move position prompt signal. The specific signal processing process is described in the aforementioned embodiments, and details are not repeated herein again.

In an embodiment, as shown in FIG. 6, the three-dimensional connect four chessboard may further include a chess move player prompt module 500 connected to the processor 300. The processor 300 is configured to generate a chess move player prompt signal. The chess move player prompt module 500 is configured to prompt a type of a chess piece to be placed according to the chess move player prompt signal. Specifically, the processor 300 may detector the spatial position information of all chess pieces in real time according to the current spatial position information and the historical spatial position information, and determine a player who needs to move next with reference to the number of the chess moves, and simultaneously generate a chess move player prompt signal. After receiving the corresponding chess move player prompt signal, the chess move player prompt module 500 may prompt a player who needs to perform the next move in light or sound prompt modes, indicating a type of a chess piece to be placed. It should be appreciated that the chess move player prompt module 500 can reduce the case of wrong sequence of chess moves in a face-to-face chess game or a man-machine chess game.

In an embodiment, the chess move player prompt module 500 may include a first display lamp and a second display lamp. The chess move player prompt module 500 is configured to control the first display lamp or the second display lamp to glow or flicker according to the chess move player prompt signal. Specifically, the first display lamp and the second display lamp are respectively provided on opposite sides of the upper panel 100. When the first display lamp or the second display lamp glows or flickers, it indicates that a corresponding player needs to move.

In an embodiment, the three-dimensional connect four chessboard may further include a wireless module 600 connected to the processor 300. The wireless module 600 is configured to acquire a wireless control signal, and the processor 300 is configured to generate a chess move position prompt signal according to the wireless control signal. Specifically, by providing the wireless module 600, the processor 300 may acquire, in a wireless mode, a wireless control signal transmitted from the server, that is, a chess move signal transmitted by a remote player. After acquiring the wireless control signal, the processor 300 may output a chess move position prompt signal to prompt the current player about the position of the chess move to be performed, thereby achieving a remote battle game effect. It should be appreciated that the remote player may transmit a corresponding chess move signal through a three-dimensional connect four chessboard. After receiving and forwarding the signal, the server transmits the corresponding chess move signal to a three-dimensional connect four chessboard of the current player, to implement the remote battle game, or the remote player may transmit the corresponding chess move signal by using a software program.

In an embodiment, a three-dimensional connect four is further provided, including chess pieces and a chessboard. The chessboard includes the three-dimensional connect four chessboard in the aforementioned embodiments. The chess pieces can be in two different colors for representing different players. A specific arrangement mode of the chess pieces can be changed according to a detection requirement of the detection module 200.

According to the three-dimensional connect four in the present disclosure, the detection module 200 is provided to detector the position of the chess move, and output a corresponding plane position signal. The processor 300 determines the spatial position information of the chess piece according to the acquired plane position signal and the number of chess moves recorded by the processor itself, and obtains position information of a chess piece to be moved next according to the spatial position information of the chess piece, and outputs the chess move position prompt signal. After receiving the corresponding chess move position prompt signal, the provided chess move position prompt module 400 may indicate the position of the chess move area 110 in which the chess move needs to be performed, in order to achieve the technical effect that the user helps the machine to perform the chess move.

The technical limitations in the above-mentioned embodiments may be combined in any manner. In order to make the description brief, all possible combinations of the technical limitations in the above-mentioned embodiments are not described. However, as long as there is no contradiction in the combinations of the technical limitations, these combinations should be considered as the scope of the present disclosure.

The above-mentioned embodiments represent only some implementation modes of the present disclosure, and descriptions thereof are relatively specific and detailed, but may not be construed as a restriction on the scope of the present disclosure. It should be noted that a person of ordinary skill in the art may make some modifications and improvements without departing from the concept of the present disclosure, which all fall within the protection scope of the present disclosure. Therefore, the protection scope of the present disclosure shall be subject to the appended claims.

1. A three-dimensional connect four chessboard, comprising:
an upper panel provided with a number of chess move areas, the chess move areas being configured to stack chess pieces, the chess move areas being arranged in an array of M rows and N columns, and both M and N being natural numbers greater than or equal to 5;
a detection module comprising a plurality of detectors each of which is provided in the corresponding chess move area and is configured to detector a chess move position of a chess piece;
a processor connected to the detection module; and
a chess move position prompt module connected to the processor and configured to indicate a position of the corresponding chess move area;
wherein the chess move position prompt module comprises a color identification assembly and a position identification assembly, the color identification assembly comprises N color identification members with different colors in each row, each color identification member is provided to correspond to one of the chess move areas, and the position identification assembly is configured to identify a row number and a color of the color identification member;
the position identification assembly comprises M row number identification lamps each of which is provided on a side of each row of color identification members, the row number identification lamp is configured to emit color light of N different colors, and the position identification assembly is configured to control a specific row number identification lamp to emit light; or the position identification assembly comprises a row number display lamp configured to display a number to identify a row number of the color identification member, emit color light of N different colors, and display a number of a specific color.

2. (canceled)

3. (canceled)

4. (canceled)

5. (canceled)

6. The three-dimensional connect four chessboard according to claim 1, wherein
the detection module is configured to output a plane position signal;
the processor is configured to determine current spatial position information of a chess piece according to the plane position signal and the number of chess moves, and output a chess move position prompt signal according to the current spatial position information and historical spatial position information;
the chess move position prompt module is configured to indicate a position of a corresponding chess move area according to the chess move position prompt signal.

7. The three-dimensional connect four chessboard according to claim 1, further comprising a chess move player prompt module connected to the processor, wherein the processor is configured to generate a chess move player prompt signal, and the chess move player prompt module is configured to prompt a type of a chess piece to be placed according to the chess move player prompt signal.

8. The three-dimensional connect four chessboard according to claim 7, wherein the chess move player prompt module comprises a first display lamp and a second display lamp, and the chess move player prompt module is configured to control the first display lamp or the second display lamp to glow or flicker according to the chess move player prompt signal.

9. The three-dimensional connect four chessboard according to claim 6, further comprising a wireless module connected to the processor and configured to acquire a wireless control signal, and the processor is configured to generate a chess move position prompt signal according to the wireless control signal.

10. A three-dimensional connect four, comprising chess pieces and a chessboard, wherein the chessboard comprises the three-dimensional connect four chessboard according to claim 1.

11. A three-dimensional connect four chessboard, comprising:
an upper panel provided with a number of chess move areas, the chess move areas being configured to stack chess pieces, the chess move areas being arranged in an array of M rows and N columns, and both M and N being natural numbers greater than or equal to 5;
a detection module comprising a plurality of detectors each of which is provided in the corresponding chess move area and is configured to detector a chess move position of a chess piece;
a processor connected to the detection module;
a chess move position prompt module connected to the processor and configured to indicate a position of the corresponding chess move area; and
wherein the chess move position prompt module comprises a position display screen provided on the upper panel, the position display screen comprises a plurality of position display lamps arranged in an array, the position display lamps have the same array arrangement mode as the chess move areas, and the position display screen is configured to control the position display lamps to glow or flicker.

12. The three-dimensional connect four chessboard according to claim 11, wherein
the detection module is configured to output a plane position signal;
the processor is configured to determine current spatial position information of a chess piece according to the plane position signal and the number of chess moves, and output a chess move position prompt signal according to the current spatial position information and historical spatial position information;
the chess move position prompt module is configured to indicate a position of a corresponding chess move area according to the chess move position prompt signal.

13. The three-dimensional connect four chessboard according to claim 11, further comprising a chess move player prompt module connected to the processor, wherein the processor is configured to generate a chess move player prompt signal, and the chess move player prompt module is configured to prompt a type of a chess piece to be placed according to the chess move player prompt signal.

14. The three-dimensional connect four chessboard according to claim 13, wherein the chess move player prompt module comprises a first display lamp and a second display lamp, and the chess move player prompt module is configured to control the first display lamp or the second display lamp to glow or flicker according to the chess move player prompt signal.

15. The three-dimensional connect four chessboard according to claim 12, further comprising a wireless module connected to the processor and configured to acquire a wireless control signal, and the processor is configured to generate a chess move position prompt signal according to the wireless control signal.

16. A three-dimensional connect four, comprising chess pieces and a chessboard, wherein the chessboard comprises the three-dimensional connect four chessboard according to claim 11.
